(19) United States
(12) Patent Application Publication
(10) Pub. No.: US 2011/0029867 A1
(43) Pub. Date: Feb. 3, 2011

(54) MUSIC REPRODUCING APPARATUS AND METHOD OF PORTABLE TERMINAL

(75) Inventor: Young-Sik PARK, Daegu (KR)

Correspondence Address: Cha & Reiter, LLC, 17 Arcadian Avenue, Suite 208, Paramus, NJ, 07652, US

(73) Assignee: SAMSUNG ELECTRONICS CO., LTD., Gyeonggi-Do (KR)

(21) Appl. No.: 12/843,987

(22) Filed: Jul. 27, 2010

(30) Foreign Application Priority Data
Jul. 29, 2009 (KR) 10-2009-0069696

(51) Int. Cl. G06F 17/00; G06F 3/01

(52) U.S. Cl. 715/702; 700/94; 715/716

(57) ABSTRACT

A music reproducing apparatus and method of a portable terminal are provided. The music reproducing apparatus includes a Graphical User Interface (GUI) for guiding users to control outputs of music files, a display for displaying the GUI, and a controller for allowing users to select music files desired to be reproduced through a plurality of channels, simultaneously reproducing the selected music files through output units corresponding to the plurality of channels, setting a reproducing time or point of a music file which is being reproduced through a specific channel, and switching the music file which is being reproduced through the specific channel to a music file which is being reproduced through another channel.

### CLAIM OF PRIORITY

This application claims the benefit of priority under 35 U.S.C. §119(a) from a Korean Patent Application filed in the Korean Intellectual Property Office on Jul. 29, 2009 and assigned Serial No. 10-2009-0069696, the entire disclosure of which is hereby incorporated by reference in its entirety.

### BACKGROUND OF THE INVENTION

1. Field of the Invention

The present invention relates generally to a music reproducing apparatus and method of a portable terminal. More particularly, the present invention relates to a music reproducing apparatus and method of a portable terminal, which provides a Disc Jockey (DJ) functions such as a turntable function and a mixer function and provides various effects to reproduced music.

2. Description of the Related Art

Recently, portable terminals have been configured to perform an ever-increasing number of various functions, including voice and data communication functions, a still or moving picture photographing function using a camera, a voice storage function, a music file reproducing function through a speaker system, and image and video display functions.

Some portable terminals include additional functions for playing games and other portable terminals can operate as multimedia devices. Recently designed portable terminals provide a television program viewing service by receiving multicast signals, and therefore users can receive various multimedia services only by a single portable terminal without the need for carrying an additional MP3 or moving picture player.

However, due to a design characteristic of small and slim conventional portable terminals, particularly as they become smaller in size and lighter in weight, the users of such conventional portable terminals having a music file reproducing function have no choice but to listen to music according to a music reproducing application which is uniformly fixed, and cannot adjust the sound to their liking. Furthermore, since music reproduced through the portable terminal is output by only either a loud speaker, through which a user can listen to music with other people, or by a headset or earphone through which only the user can listen to music, users cannot satisfactorily enjoy listening to music reproduced through the portable terminal.

Meanwhile, techniques performed by a DJ may include mixing and scratching functions. The mixing technique is the most fundamental and essential technique which naturally connects two different songs by approximating their Beats Per Minute (BPM). The scratching is a part which allows DJs to fully express their own unique personality and indicates peculiar sound generated when a specific sound part of a record in which music has been recorded moves back and forth. Scratching was originally used with vinyl records on a photograph/turntable, whereby the DJ would manually grab the rotating record and temporarily stop the rotation, or sometimes pull the record in a counter-rotation top making a scratching/screeching sound by the stylus.

The basic equipment necessary for DJs is two turntables and a mixer. The turntables enable users to listen to music through LP records. The mixer combines sounds input through multiple channels to make music reproduced through the two turntables sound natural. A crossfader coupled to the mixer is one of the most important devices for scratch and generates various scratch sounds.

To perform such DJ functions, many sound devices, which are bulky and inconvenient to carry, are required. In addition, DJ functions require professional experience and knowledge to express lots of personality to fixedly reproduced music.

In a mobile device such as a portable terminal, music is reproduced according to a musical reproducing application through either a loud speaker or an earphone. Therefore, it is not possible to reproduce music suitable for user's preference and to reproduce a user's unique creative music. Moreover, when music is generated through only any one of the loud speaker and the earphone, additional music cannot be simultaneously generated.

Furthermore, since analog devices, such as a turntable, an amplifier and a sound mixer, which are necessary to perform professional DJ functions, are bulky and provides restricted mobility, and it is difficult to apply those devices to a portable terminal due to a slim and small design trend of the portable terminal.

### SUMMARY OF THE INVENTION

An exemplary aspect of the present invention is to provide a music reproducing apparatus and method for a portable terminal, which can achieve DJ mixer functions, such as storage and selection of music, selection of a cue, and audible reproduction and switching of music, that uses a plurality of channels and a plurality of output units corresponding to the plurality of channels. According to the present invention, by reproducing music in various ways, allowing users to express their own personality, improving user's convenience by mixing simultaneously reproduced music, and increasing utility of music according to music reproduction.

In accordance with another exemplary aspect of the present invention, a music reproducing apparatus of a portable terminal preferably includes a Graphical User Interface (GUI) for guiding users to control outputs of music files, a display for displaying the GUI, and a controller for allowing users to select music files desired to be audibly reproduced respectively through a plurality of channels, simultaneously audibly reproducing the selected music files through output units corresponding to the plurality of channels, setting a reproducing time or point of a music file which is being audibly reproduced through a specific channel, and switching from a current music file which is being audibly reproduced through the specific channel to another music file which is being audibly reproduced through another channel.

According to another exemplary aspect of the present invention, the GUI includes a main view for displaying information about a particular music file which is being reproduced through at least one channel by loading music files of the plurality of channels, and displaying a cue for setting a specific reproducing time or point of the particular music file which is being reproduced on a process bar of the particular music file when switching from the current music file to the particular music file is demanded; a wave view for displaying waveforms of music files which are being audibly reproduced respectively through the plurality of channels and providing a user interface which allows users to select a cue for the particular music file desired to be reproduced subsequent to reproduction of the current music file; and a mixer view for displaying a result of generating music files which are being audibly reproduced through the plurality of channels as one mixed music file by setting a cue for switching from the current music file which is being reproduced through a specific channel to the particular music file to be reproduced subsequently.

A person of ordinary skill in the art understands that the term “reproduces” in this circumstance indicates a playing of a music file output to a transducer. In accordance with still another exemplary aspect of the present invention, a music reproducing method of a portable terminal includes sensing that a general call standby mode is converted to a music reproducing mode by preset mode conversion information, displaying a Graphical User Interface (GUI) for guiding users to control outputs of music files, allowing users to select music files desired to be audibly reproduced through a plurality of channels and simultaneously audibly reproducing the selected music files through output units corresponding to the plurality of channels, displaying information about a music file which is being audibly reproduced through a specific channel according to user input, setting a reproducing time or point of the music file, and switching the music file to another music file at the set reproducing time or point, and mixing the music files having outputs of different channels to generate one music file.

### BRIEF DESCRIPTION OF THE DRAWINGS

The above and other exemplary aspects, features and advantages of certain exemplary embodiments of the present invention will become more apparent from the following description taken in conjunction with the accompanying drawings, in which:

FIG. 1 is a perspective view of a portable terminal to which a technique of a music reproducing apparatus and method is applied according to an exemplary embodiment of the present invention;

FIG. 2 is a block diagram of a music reproducing apparatus of a portable terminal according to an exemplary embodiment of the present invention;

FIG. 3 is a flow chart illustrating exemplary operation of a music reproducing process of a portable terminal according to an exemplary embodiment of the present invention; and

FIGS. 4A to 4C are diagrams illustrating examples of a GUI screen provided through a music reproducing process of a portable terminal according to an exemplary embodiment of the present invention.

Throughout the drawings, the same drawing reference numerals will be understood to refer to the same elements, features and structures.

### DETAILED DESCRIPTION

Reference will now be made in detail to the exemplary embodiments of the Music Reproducing Apparatus and Method of a Portable Terminal according to the present invention with reference to the accompanying drawings. The following detailed description includes specific illustrative details in order to provide a thorough understanding of the present invention. However, it will be apparent to those skilled in the art that the presently invention may be practiced without such illustrative details.

For a complete understanding of the present invention, a basic principle of the present invention will now be described. A music reproducing apparatus of a portable terminal according to an exemplary embodiment of the present invention may be included in various portable devices such as, for example, a cellular phone, a digital camera, a navigation system, a Portable Multimedia Player (PMP), and the like. Accordingly, a portable terminal described hereinbelow refers to such a multifunctional portable device which can reproduce audio files.

Music files according to an exemplary embodiment of the present invention refer to files supported in various forms, such as MP3 files, OGG files, Windows Media Audio (WMA) files, and Active Streaming Format (ASF) files. The aforementioned files are only examples and do not limit the claimed invention to the files of the aforementioned types.

In the present invention, a rotating turntable image is displayed on a touch screen in a circular disc form so as to perform DJ functions while music is reproduced. A user may directly control a disc of a music file using the touch screen in a manner to some degrees mimics the control of a disc on an actual turntable.

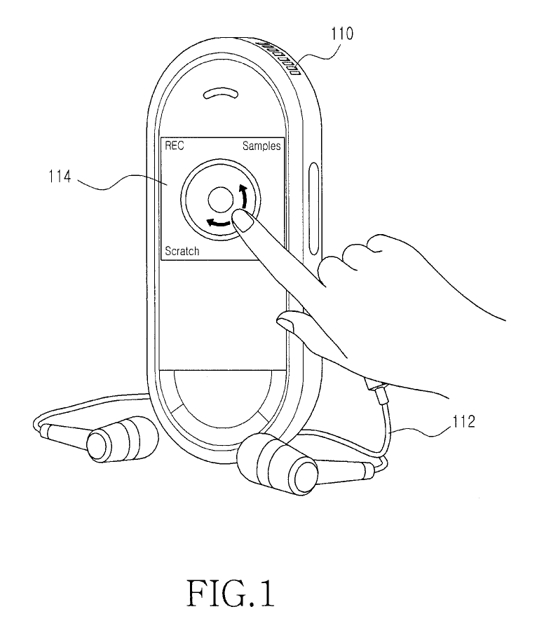

FIG. 1 illustrates an overall configuration of a portable terminal to which a technique of a music reproducing apparatus and method is applied according to an exemplary embodiment of the present invention.

Referring now to FIG. 1, the portable terminal for achieving DJ functions includes a loud speaker output unit 110 installed at one side thereof, a headset or an earphone output unit 112 provided at another side thereof, and a display 114. The display 114 is implemented preferably as a touch screen type.

As illustrated in FIG. 1, a user may achieve the DJ functions, such as beat mixing and scratching, by touching, using the user's finger or stylus, of a Graphical User Interface (GUI) 116 of a disc form corresponding to a currently reproduced music file displayed on the display 114. Namely, when touch input by a user is generated on the GUI 116 of a disc form, the GUI 116 rotates to the left and right, senses a rotating direction or rotating degree, and provides the sensed signal to a controller, which will be described later on, thereby generating sound effects such as preset scratch.

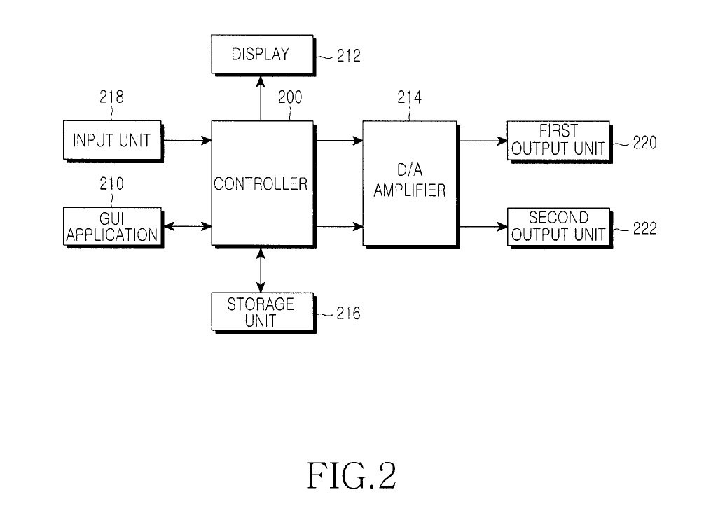

A music reproducing apparatus of a portable terminal having a DJ mixing function according to an exemplary embodiment of the present invention will now be described with reference to FIG. 2.

Referring now to FIG. 2, the music reproducing apparatus of the portable terminal preferably includes a controller 200, a GUI application 210, a display 212, a Digital-to-Analog ((D/A) amplifier 214, a storage unit 216, an input unit 218, a first output unit 220, and a second output unit 222.

The controller 200, which may be a microprocessor, controls the overall operation of the portable terminal. The controller 200 typically allows a user to select music files to be reproduced through a plurality of channels, reproduces the selected music files through the output units 220 and 222 corresponding to the respective channels, sets a reproducing time or a reproducing point of a music file which is being reproduced through a specific channel, and switches the music file to a music file which is being reproduced through another channel.

In addition, the controller 200 mixes music files of different channels to generate one music file by setting a reproducing time or point of a music file which is being reproduced through a specific channel among a plurality of channels and switching the music file to a music file of another channel at the set reproducing time or point. The reproducing time or point indicates a reproducing start or end of a music file.

For example, a user may listen to music with other people by reproducing first music file signals generated through the first output unit 220, which is a loud speaker output unit, and simultaneously may listen, together with the first music file signal generated through the first output unit 220, second music file signals generated through the second output unit 222, which is an earphone or headset output unit.

In this particular example, a user may set a specific reproducing stop time or point of a first music file which is being reproduced through the first output unit 220 and may also set a specific reproducing start time or point of a second music file which is being reproduced through the second output unit 222. Then, the controller 200 switches the specific reproducing stop time or point set in the first music file reproduced through the first output unit 220 into the specific reproducing start time or point set in the second music file reproduced through the second output unit 222.

The controller 200 then outputs, through the first output unit 220, a music file at a specific reproducing time or point set in the second music file following a specific reproducing time or point set in the first music file.

The controller 200 also mixes the first and second music files through switching at the specific reproducing time or point to generate one music file and stores the generated music file in the storage unit 216.

The plurality of channels may be divided into, for example, a first channel and a second channel. The first and second channels may be preset to correspond to the first and second output units 220 and 222, respectively.

With continued reference to FIG. 2, more specifically, the controller 200 loads music files stored in the storage unit 216 through the first and second channels to select music files to be reproduced and controls the output units 220 and 222 to simultaneously output music files selected through the respective channels.

The GUI application 210 guides a user to control the outputs of music files. Upon sensing touch input by a user through the input unit 218, the GUI application 210 adjusts a shape of GUI by the control of the controller 200 in accordance with the touch.

In more detail, the GUI application 210 refers to an initial screen informing a user that a music reproducing mode is started when the user request to convert a general call standby mode to the music reproducing mode. The GUI application 210 preferably includes a main view, a wave view, and a mixer view.

With regard to the multiple views, the main view displays information about a music file which is being reproduced through at least one channel by loading music files of the plurality of channels, and displays a cue for setting a specific reproducing time or point of the music file which is being reproduced on a process bar of the music file.

In addition, the wave view displays waveforms of music files which are being reproduced through the plurality of channels and provides a User Interface (UI) which allows users to select a cue of a music file desired to be reproduced after the music files which are being reproduced.

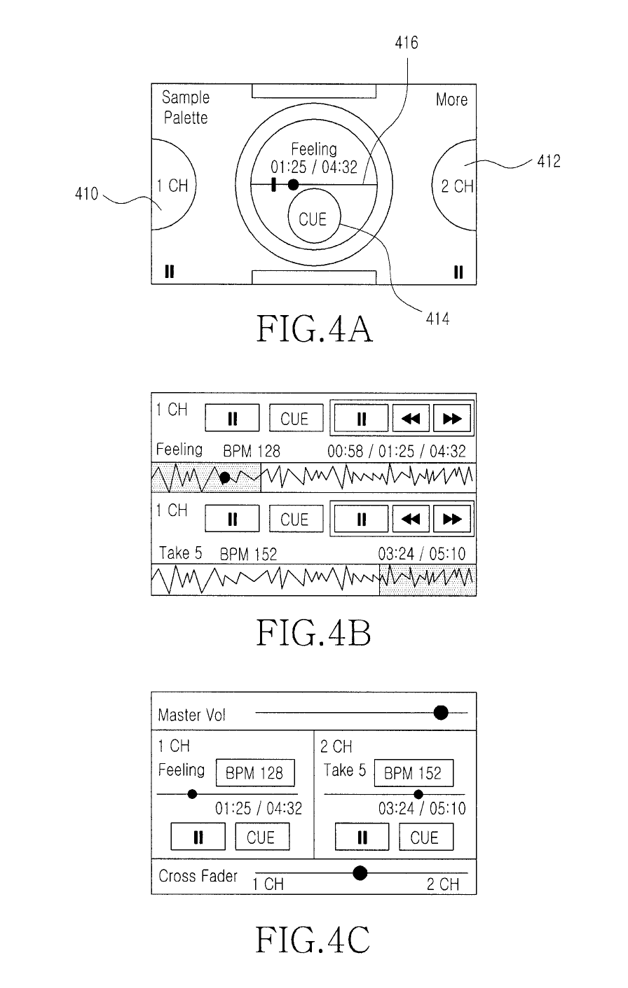

Finally, the mixer view displays a result of generating music files which are being reproduced through the plurality of channels as one single music file by setting a cue of switching a music file which is being reproduced through a specific channel to a music file to be reproduced subsequently. The three views will be described in more detail subsequently with reference to FIGS. 4A, 4B and 4C.

With continued reference to FIG. 2, the storage unit 216 is preferably comprised of program memories and data memories. The program memories may store programs for controlling a general operation of the portable terminal and stores a plurality of music files which can be loaded through a plurality of channels according to an exemplary embodiment of the present invention. The storage unit 216 stores music files which are generated by being mixed through the respective channels by the control of the controller 200.

The D/A amplifier 214 converts signals of music files generated through a plurality of channels into analog signals.

Music file signals of the respective channels, received from the D/A amplifier 214, are generated through the first and second output units 220 and 222 which are preset to correspond to the respective channels.

According to an exemplary aspect of the present invention, the input unit 218 senses a user's touch input on a prescribed area and provides an input signal to the controller 200. For example, if the GUI of a disc-shaped form on the display 212 rotates to the left and/or right (e.g. clockwise or counterclockwise) according to the user's touch input, the input unit 218 senses the rotating direction or rotating degree and provides a signal according to the rotating direction or rotating degree to the controller 200 so as to generate preset sound effects such as scratch.

Namely, a user generates input data for the operational control of the portable terminal. The input unit 218 may include any of a key pad, a dome switch, a touch pad, a jog wheel, a jog switch, etc. If the touch pad forms a layer structure with the display 212, the touch pad may be recognized as a touch screen.

With continued reference to FIG. 2, the display 212 displays information processed by the portable terminal through a GUI by the control of the controller 200. For example, if the portable terminal is in a call mode, the display 212 displays a UI or GUI associated with a call. If the portable terminal is in a music reproducing mode, the display 212 displays a GUI associated to music file information and output.

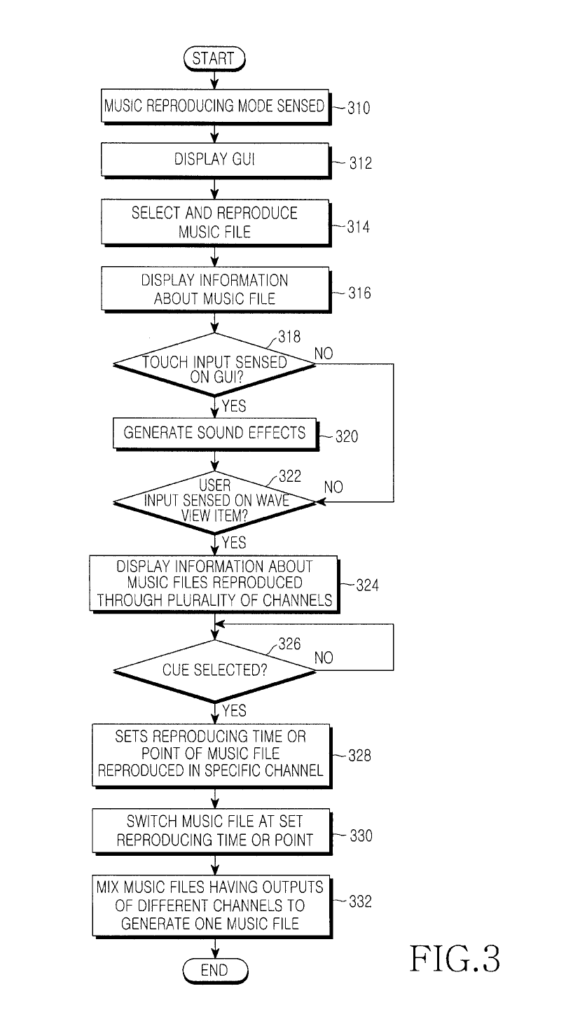

A music reproducing process of a portable terminal using the above-described music reproducing apparatus will now be described with reference to FIG. 3.

FIG. 3 is a flow chart illustrating a music reproducing process of a portable terminal according to an exemplary embodiment of the present invention.

Referring now to FIG. 3, at step 310 the controller 200 senses that a user enters a music reproducing mode from a prescribed mode such as a general call standby mode by preset mode conversion information.

At step 312, the controller 200 displays, on the display 212, a GUI which guides users to control outputs of music files. The controller 200 changes a shape of the GUI according to touch input by users.

In the music reproducing mode, an initial GUI is displayed on the display 212a and the initial GUI includes a main view, a wave view, and a mixer view as shown in FIGS. 4A, 4B and 4C, respectively.

FIGS. 4A to 4C are diagrams illustrating examples of a GUI screen provided through a music reproducing process of a portable terminal according to an exemplary embodiment of the present invention.

The main view shown in FIG. 4A displays information about a music file which is being reproduced through at least one channel (e.g. a first channel 410 or a second channel 420) by loading music files through the plurality of channels, and displays a cue 414 for setting a specific reproducing time or point of the reproduced music file on a process bar 416.

The wave view shown in FIG. 4B displays waveforms of music files and provides a UI which allows users to select a cue of a music file desired to be reproduced after the music files which are being reproduced, in order to approximate and naturally connect BPM of different music files which are being reproduced through a plurality of channels.

The mixer view shown in FIG. 4C displays a result of generating music files which are being reproduced through the plurality of channels as one music file by setting a cue of switching a music file which is being reproduced through a specific channel to a music file to be reproduced subsequently.

In step 314, the controller 200 loads music files through a plurality of channels (i.e. the first channel 410 and the second channel 412) displayed on the main view of FIG. 4A to select and reproduce a music file.

At step 316, the controller 200 displays information about a music file which is being reproduced through a specific channel. For example, the controller 200 may display a music title ('Feeling'), a reproducing time (04:32), and a reproducing point (01:25) as shown in FIG. 4A.

At step (318), if touch input by a user is sensed on the GUI showing information about the reproduced music file, the controller 200 generates preset sound effects.

As shown in FIG. 4A, the GUI of a circular disc form including the cue 414 and the process bar 416 on the main view is used to achieve DJ functions. For example, the portable terminal has previously been set to generate fricative sound of an LP, such as scratch, if a user scrubs the GUI using the user's hand. The touch input by a user in step 318 refers to several different types of touch that include but is not limited to a short touch, long touch, flicking or drag operation.

At step 318 there is touch input sensed, e.g. generated on the GUI, then at step 320 sound effects are generated in accordance with the type of touch made to the GUI, such as shown in FIG. 4A. However, if at step 318, no touch input is generated on the GUI showing information about the reproduced music file, then at step 322 the controller 200 checks whether or not a touch input is generated on a wave view item in a prescribed area (e.g. 418 or 420) of the main view.

If the touch input is generated at step 322, then at step 324 the controller 200 displays information about music files which are being reproduced through a plurality of channels as illustrated in FIG. 4B.

The wave view, an example of which is shown in FIG. 4B, displays waveforms of music files which are being reproduced through a plurality of channels in order to approximate and naturally connect BPM of different music files.

Moreover, the wave view displays GUI items for cues which have already been set in a plurality of channels, or which can be set by the user.

At step 326, the controller 200 checks whether a cue is selected on the wave view. If a cue is selected, then at step 328 the controller 200 sets a reproducing time or point of a music file which is being reproduced through a specific channel.

At step 330, the controller 200 switches the music file which is being reproduced through the specific channel into a music file which is being reproduced through another channel at the set reproducing time or point.

At step 332, the music files having outputs of different channels are mixed to generate one music file as shown in the mixer view of FIG. 4C. The mixer view displays a result of generating music files which are being reproduced through the plurality of channels as one music file by setting a cue of switching a music file which is being reproduced through a specific channel to a music file to be reproduced subsequently.

According to exemplary embodiments of the present invention, the music reproducing apparatus of the portable terminal enables different music files to be reproduced or switched through a plurality of channels and corresponding output units. Therefore, users can express their personality through music. In addition users can perform DJ functions such as described above that heretofore were not possible with a conventional portable terminal. Further, since different music is simultaneously reproduced through a plurality of channels and music can be switched between different channels, users can enjoy music seamlessly according to their preference.

In addition, since the music reproducing apparatus provides various GUIs through a display of the portable terminal, users can perform the DJ functions and roles without having any professional DJ experience and knowledge.

It is within the spirit and scope of the claimed invention that, for example, one of a clockwise or counter-clockwise rotation of the disc by touch may fast forward the current music file, and the other of a clockwise or counter-clockwise generates a preprogrammed fricative output sound for a predetermined period of time in place of the current music file.

The above-described methods according to the present invention can be realized in hardware or as software or computer code that can be stored in a recording medium such as a CD ROM, a RAM, thumbnail drive, a floppy disk, a flash storage, a hard disk, or a magneto-optical disk or downloaded over a network and stored in storage, so that the methods described herein can be executed by such software using a general purpose computer, special computer, microprocessor, special processor, or in a programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the exemplary embodiments of the present invention have been disclosed for illustrative purposes, various modifications, additions and substitutions are possible, without departing from the scope and spirit of the invention as disclosed in the accompanying claims. For example, in the presently claimed invention, multimedia files can be selected mixed and thus the music files are required to be an audio only file. Accordingly, the scope of the present invention should not be limited to the description of the embodiment, but defined by the accompanying claims and equivalents thereof.

What is claimed is:

1. A music reproducing apparatus of a portable terminal, comprising:
a Graphical User Interface (GUI) for guiding users to control outputs of music files;
a display for displaying the GUI; and
a controller for allowing users to select music files desired to be audibly reproduced respectively through a plurality of channels, simultaneously audibly reproducing the selected music files through output units corresponding to the plurality of channels, setting a reproducing time or point of a music file which is being audibly reproduced through a specific channel, and switching from a current music file which is being audibly reproduced through the specific channel to another music file which is being audibly reproduced through another channel.

2. The music reproducing apparatus of claim 1, wherein the GUI includes:
a main view for displaying information about a particular music file which is being reproduced through at least one channel by loading music files of the plurality of channels, and displaying a cue for setting a specific reproducing time or point of the particular music file which is being reproduced on a process bar of the particular music file when switching from the current music file to the particular music file is demanded;
a wave view for displaying waveforms of music files which are being audibly reproduced respectively through the plurality of channels and providing a user interface which allows users to select a cue for the particular music file desired to be reproduced subsequent to reproduction of the current music file; and
a mixer view for displaying a result of generating music files which are being audibly reproduced through the plurality of channels as one mixed music file by setting a cue for switching from the current music file which is being reproduced through a specific channel to the particular music file to be reproduced subsequently.

3. The music reproducing apparatus of claim 1, wherein the controller performs the switching by mixing music files output through different respective channels to generate mixed music files comprising one mixed music file.

4. The music reproducing apparatus of claim 1, wherein the display is implemented with a touch screen.

5. The music reproducing apparatus of claim 2, wherein the main view displays an image of the music file which is being reproduced, in the form of a rotating disk.

6. The music reproducing apparatus of claim 5, wherein the controller generates sound effects by adjusting rotating motion of the image of the disk form according to a touch input by a user.

7. The music reproducing apparatus of claim 6, wherein the touch input includes a short touch, long touch, flicking, or drag operation.

8. The music reproducing apparatus of claim 6, wherein one of a clockwise or counter-clockwise rotation of the disc by touch fast forwards the current music file, and the other of a clockwise or counter-clockwise generates a preprogrammed fricative output sound for a predetermined period of time in place of the current music file.

9. The music reproducing apparatus of claim 1, wherein the output units include a loud speaker output unit and a headset output unit.

10. A music reproducing method of a portable terminal, comprising:
determining by a controller that a general call standby mode is converted to a music reproducing mode by preset mode conversion information;
displaying a Graphical User Interface (GUI) for guiding users to permit control outputs of music files;
audibly reproducing user-selected music files desired to be audibly reproduced respectively through a plurality of channels and simultaneously reproducing the selected music files through output units corresponding to the plurality of channels;
displaying information about a current music file which is being reproduced through a specific channel according to user input, setting a reproducing time or point of the current music file, and switching reproduction from the current music file to another music file at the set reproducing time or point; and
mixing the selected music files having outputs from different channels to generate one mixed music file.

11. The music reproducing method of claim 10, wherein the reproducing time or point comprises a reproducing start or end operation of a particular music file.

12. The music reproducing method of claim 10, wherein the GUI includes:
a main view for displaying information about a particular music file which is being reproduced through at least one channel by loading music files of the plurality of channels, and displaying a cue for setting a specific reproducing time or point of the particular music file which is being reproduced on a process bar of the particular music file when switching from the current music file to the particular music file is demanded;
a wave view for displaying waveforms of music files which are being audibly reproduced respectively through the plurality of channels and providing a user interface which allows users to select a cue for the particular music file desired to be reproduced subsequent to reproduction of the current music file; and
a mixer view for displaying a result of generating music files which are being audibly reproduced through the plurality of channels as one mixed music file by setting a cue for switching from the current music file which is being reproduced through a specific channel to the particular music file to be reproduced subsequently.

13. The music reproducing method of claim 10, wherein the output units include a loud speaker output unit and a headset output unit.

14. The music reproducing method of claim 12, wherein the main view displays an image of the music file which is being reproduced, in the form of a rotating disk.

15. The music reproducing method of claim 14, further comprising generating sound effects by the controller in response to adjusting a rotating motion of the image of the disk form according to a touch input by a user.

16. The music reproducing method of claim 15, wherein the touch input includes a short touch, long touch, flicking, or drag operation.

17. The music reproducing method of claim 15, wherein one of a clockwise or counter-clockwise rotation of the disc by touch fast forwards the current music file, and the other of a clockwise or counter-clockwise generates a preprogrammed fricative output sound for a predetermined period of time in place of the current music file.
